(19) United States
(12) Patent Application Publication
(10) Pub. No.: US 2010/0241532 A1
(43) Pub. Date: Sep. 23, 2010

(54) SYSTEM, METHOD, AND COMPUTER PROGRAM PRODUCT FOR THIRD-PARTY AND FOURTH-PARTY LOGISTICS

(76) Inventors: Paul Biddle, Summerville, SC (US); Thomas Shanon, Columbia, SC (US); Ross Heaton, Mount Pleasant, SC (US)

Correspondence Address: Jason Scott Luck, 165-A King Street, Charleston, SC, 29401, US

(21) Appl. No.: 12/726,160

(22) Filed: Mar. 17, 2010

Related U.S. Application Data
(60) Provisional application No. 61/160,802, filed on Mar. 17, 2009.

(51) Int. Cl. G06Q 10/00

(52) U.S. Cl. 705/28; 705/301

(57) ABSTRACT

The present invention provides a system and method for managing supply chain, goods handling, and logistics services for third-party and fourth-party logistics providers (asset-based and non-asset based). The invention provides logistics provider(s) with the functionality to manage and organize multiple supply chain service providers, and the services they provide, in order to maximize efficiency and profit and minimize cost to the customer(s) of the logistics provider(s).

### CROSS-REFERENCE TO RELATED APPLICATIONS

This application claims priority under 35 U.S.C. §119 to, and incorporates by reference, U.S. Provisional Patent Application No. 61/160,802, entitled “System, Method, And Computer Program Product For Third-Party And Fourth-Party Logistics.”

### STATEMENT REGARDING FEDERALLY SPONSORED RESEARCH OR DEVELOPMENT

N/A

### THE NAMES OF THE PARTIES TO A JOINT RESEARCH AGREEMENT

N/A

### REFERENCE TO A “SEQUENCE LISTING”

N/A

### DESCRIPTION OF RELATED ART INCLUDING INFORMATION DISCLOSED UNDER 37 CFR 1.97 AND 37 CFR 1.98.

US 2002/0049622 A1 (Lettich); U.S. Pat. No. 7,376,600 B1 (Wadawadigi); US 2003/0172007 A1 (Helmolt); US 2006/0192673 A1 (Irwin); US 2002/0133387 A1 (Wilson); US 2003/0233246 A1 (Snapp); US 2002/0188513 A1 (Gil); US 2004/0225624 A1 (Reynolds); U.S. Pat. No. 7,233,914 B1 (Wijaya); US 2007/0124009 A1 (Bradley); US 2004/0084526 A1 (Knowles); U.S. Pat. No. 7,315,826 B1 (Guheen); U.S. Pat. No. 7,165,041 B1 (Guheen); US 2003/0046089 A1 (Menninger); U.S. Pat. No. 7,324,966 B2 (Scheer); US 2003/0069819 A1 (Chen); US 2004/0044557 A1 (Frech); WO 2002/049257 A2 (Junger); US 2005/0015377 A1; US 2002/0188496 A1 (Feldman); U.S. Pat. No. 4,847,761 A (Ferriter); US 2003/0172200 A1 (Chen)

See also:

http://www.warehousenews.co.uk/News/January_{—}2007/E-foursoft_interview.html http://www.kencogroup.com/www/docs/108.48/warehouse-efficiency-system.html http://ieeexplore.ieee.org/Xplore/login.jsp?url=/iel5/8811/27871/01243919.pdf?ar number=1243919

http://www.turtlesoft.com/small-business-software/retail-business-software.html http://www.cargowise.com/solutions/enterprise-warehouse.shtml http://www.capterra.com/logistics-software/spotlight/22485/Chainware/Interchain?id=7111164 http://systems.almyta.com/software_research/warehouse_inventory_management_software_{—}20060922090345_c.asp

### COPYRIGHT DISCLAIMER

A portion of the disclosure of this patent document may contain material that is subject to copyright protection. The copyright owner has no objection to the facsimile reproduction by anyone of the patent document or the patent disclosure as it appears in the patent and trademark office patent file or records, but otherwise reserves all copyright rights whatsoever.

### FIELD OF THE INVENTION

The present Invention relates to the technical field of logistics, and more specifically in the field of third-party and fourth-party logistics.

### BACKGROUND OF THE INVENTION

A Fourth Party logistics provider (“4PL”) is a supply chain company that provides a wide variety of goods handling and logistics services for producers and manufacturers. The scope of these logistics services can be all-encompassing in support of a manufacturer, e.g. the handling of raw materials for production or finished goods on a global scale. Some 4PLs are non-asset-based, i.e. these 4PLs do not own certain large fixed assets such as warehouses, trucks, ships, aircraft, or rail assets. However, they do have contractual agreements with logistics companies that do own such assets. A 4PL makes money by purchasing specific services from their extensive network of logistics providers and selling those services to their customer at a higher price. The difference between the purchase price and the selling price represents the 4PL profit margin.

Many manufacturers and producers outsource logistics and handling services so that they may concentrate on the company's core competency. There may be requirements unique to their business that makes it more cost effective to outsource logistics services. For example, a toy manufacturer may be required to produce a majority of their goods for the Christmas season. The toy manufacturer will have a virtually empty warehouse for 70% of the year so it will be more cost effective to outsource this warehousing requirement to a Third Party Logistics (“3PL”) provider. The same situation can be applicable to agricultural producers who require the majority of their storage space at harvest time.

The 4PL will typically contract with a number of specialized service providers to deliver a highly customized suite of services for each customer so that they may cost effectively meet the customer's specific logistics requirements. These services are provided by what are known as Supply Chain Service Providers (“SCSP”) and include: customs brokerage, transportation services (e.g. truck, rail, air, and ship), drayage, and warehouse services, as well as other required services.

### BRIEF SUMMARY OF THE INVENTION

The purpose of the present Invention is to provide 3PLs and 4PLs with a computerized means to provide goods handling and logistics services for their customers from a 3PL and other SCSPs.

### BRIEF DESCRIPTION OF THE DRAWINGS

FIG. 1 shows an embodiment of the Invention containing, inter alia, purchase/sell functionality.

FIG. 2 shows an embodiment of the Invention containing, inter alia, purchase/sell functionality with automatic handling functionality.

### DETAILED DESCRIPTION OF THE INVENTION

Before describing the Invention in detail, it should be observed that the present Invention resides primarily in a novel and non-obvious combination of elements and process steps. So as not to obscure the disclosure with details that will readily be apparent to those skilled in the art, certain conventional elements and steps have been presented with lesser detail, while the drawings and specification describe in greater detail other elements and steps pertinent to understanding the Invention.

The following embodiments are not intended to define limits as to the structure of method of the Invention, but only to provide exemplary constructions. The embodiments are permissive rather than mandatory and illustrative rather than exhaustive.

The present Invention provides a non-asset-based 4PL with a computerized means to provide goods handling and logistics services for their customers from 3PLs and SCSPs. The envisioned user is a 4PL, 3PL, or SCSP operator in a global supply chain. A 4PL is a supply chain service trader who may or may not be asset-based; a 3PL is asset-based and are typically warehouse operators; an SCSP may be, by way of example, customs brokers, transportation providers, and lumpers.

### Users

The Invention requires that each user and each user's rights and privileges be defined within the Invention. Examples of users, their rights and privileges, include:

“Company-Level” Users whose job functions may require them to make company-wide changes to the Invention, such as changing the look and feel of the user interface. There may only one user with this level access, since few employees are apt to have a need to make changes at the company level.

“System Administrator” The System Administrator maintains the Invention's database and user access to this database.

“Customer Administrator” A Customer Administrator can be designated for each of customer, performing system-level tasks (such as customer user access, passwords, etc.) within the customer account. The System Administrator would create a Customer Administrator for any or all of the customers.

“Third Party Logistics” or “Distribution Center”: Users whose job functions are directly involved with warehouse operations (i.e. distribution). This group of users is typically the largest, as numerous operations employees may have a need to perform the functions allowed at this access level. Examples of the functions at this level include managing receipt of items, managing the handling of items, and the shipment of goods on behalf of a 4PL or its customer.

“Customer-Level” Users who are direct customers of a 4PL. If authorized, 4PL customers would be able to perform a variety of tasks on their own account, including placing new orders or checking the status of existing orders, receiving reports, performing queries of stock on-hand, and other routine tasks.

“Client-Level” Users who are a customer's customers. If the 4PL customers desire, their own customers can gain access to information such as pricing, available stock, and pending orders. Administration of access at this level is typically handled by a Customer Administrator.

### Buy/Sell Functionality

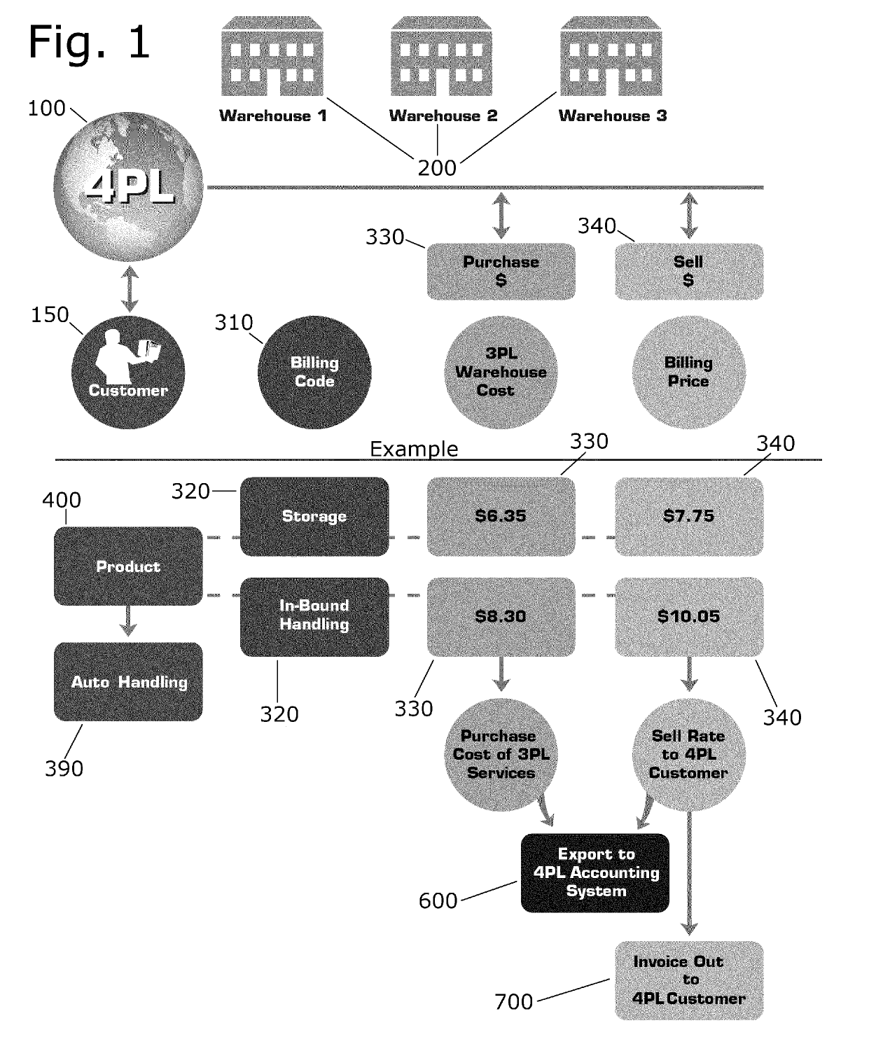

Referring to one embodiment, FIG. 1, the Invention's buy/sell functionality allows a 4PL 100 to negotiate with 3PLs or SCSPs in any location (in this embodiment 1 to N 3PL warehouses 200), to achieve the best possible suite of services to provide to its Customer(s) 150 for each product. Each Rate Schedule 300 is associated with a single Product 400. Each Rate Schedule 300 contains one or more Billing Codes 310; each Billing Code 310 is associated with a single 3PL or SCSP Service 320. Each Billing Code 310 is associated with a Buy Rate 330 and Sell Rate 340.

An unlimited number of Rate Schedules 300 are possible. Each Rate Schedule 300 is specific to each Customer 150 and Product 400 and provides a detailed breakdown of material handling services in each warehouse 200 location around the world, as well as other supply chain services.

In another embodiment each Rate Schedule 300 is associated with a single warehouse 200.

### Receipt Storage

An example of a 3PL or SCSP Service 320 is receipt storage (initial storage), a fee assessed for goods that are received, housed and handled on behalf of a customer. If a product is received at any time in the first half of the month, 100% of the agreed total monthly storage fee is applied. If a product is received after the 15th day of the month, then 50% of the monthly storage fee is applied. In some cases the 4PL, 3PL, or SCSP may agree to give the customer a certain number of “free days” as part of their agreement. The Invention will allow the user to designate a number of “free” days on a product by product basis.

### “Cross-Docked” Handling

As an additional example of a 3PL or SCSP Service 320 is handling “cross-docked” products. In some situations the customer's goods are “cross-docked”, i.e. they come into the warehouse 200 and are sorted and reshipped as soon as possible, usually the same day.

### Automatic Handling

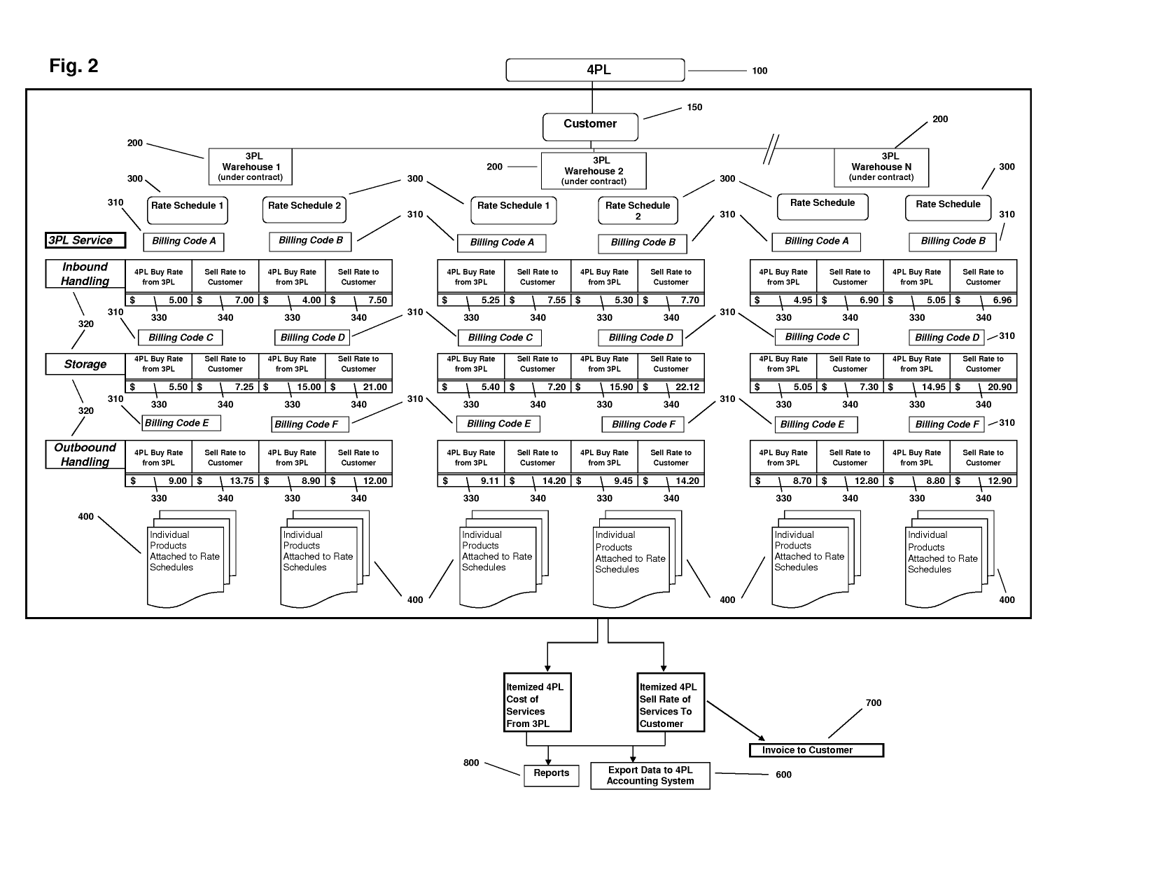

In another embodiment, FIG. 2, the Invention contains automatic handling functionality 390, used by 4PLs when product(s) 400 arrive(s) at a 3PL (warehouse) 200 that is under contact to handle the product(s) 400 on behalf of the 4PL customer. Product(s) 400 arriving at the warehouse 200 is/are received and placed in the warehouse 200 automatically and the Invention generates a paper or electronic receipt 750 (not shown) for the 4PL. The electronic receipt can also be transmitted to the 4PL via electronic means.

The status of the product(s) can be available for shipment or not available for shipment (“on hold”); the Invention communicates the status of the product(s) to the 4PL, 3PL, or SCSP in real-time, providing the 4PL, 3PL, or SCSP only the information it needs to know (e.g. Are the product(s) in a warehouse? Are the product(s) available?) and simplifying the logistics process.

### Anniversary Storage

In another embodiment, the Invention charges the Customer 150 for storage in a warehouse 200 on a periodic basis from a set date or from when the Product(s) 400 arrive(s) in a warehouse 200.

### Invoicing

In another embodiment, FIG. 1, the Invention also creates an Invoice 700 for each Customer 150 that details the Services 320 provided and the associated costs in each service provider in any location (in this embodiment a warehouse 200). The Invoice 700 may be prepared in summary form or may provide detailed information on Sell Rates 340. The Invention may generate the invoice periodically or at the instance of a user.

### Reporting

In another embodiment, FIG. 2, the Invention can generate a paper or electronic Report 800 on the status of product(s) in the 3PL warehouse, including, but not limited to information on: product(s) received, product(s) shipped, product(s) available for shipment and product(s) on hold. A Report 800 is generated periodically or at the instance of a user.

The user requesting the Report 800, or the client receiving the Report 800, will have the information limited based on the rights and privileges granted the user by the Invention, described above under “USERS”. For example, certain users may only be able to log into the system and view inventory and/or Reports 800 at only one warehouse location, while others have access to view inventory and/or Reports 800 at all warehouse locations.

### Export of Information

In another embodiment, the information in the Receipts, Reports, and Invoices may be compiled and exported 600 to the 4PL's, 3PL's, or SCSP's external accounting systems.

While the foregoing written description of the Invention enables one of ordinary skill to make and use what is considered presently to be the best mode thereof, those of ordinary skill will understand and appreciate the existence of variations, combinations, and equivalents of the specific embodiment, method, and examples herein. The Invention should therefore not be limited by the above described embodiment, method, and examples, but by all embodiments and methods within the scope and spirit of the Invention as claimed.

What is claimed is:

1. A system, method, and computer program for facilitating goods handling and logistics services in commerce comprising:
A computer network;
One or more servers functionally connected to said network;
One or more network access device(s) functionally connected to said network operative to perform functionality including graphical and text user interface and the capability to perform and direct operations;
One or more users;
One or more goods handling and logistics services within a supply chain;
One or more customers.

2. The system, method, and computer program of claim 1, where the user(s) of the Invention comprises one or more 4PLs.

3. The system, method, and computer program of claim 1, where the user(s) of the Invention comprises one or more 3PLs.

4. The system, method, and computer program of claim 1, further comprising systems and methods that are able to calculate the purchase and sale prices of goods handling or logistics services by 3PLs or SCSPs and the related profit or loss for the use of said products or services.

5. The system, method, and computer program of claim 1, further comprising systems and methods that are able to calculate the cost of use of goods handling or logistics service(s) by 3PLs or SCSPs.

6. The system, method, and computer program of claim 1, further comprising systems and methods that are able to calculate the cost of use of goods handling or logistics service(s) in a 3PL or SCSP warehouse based on amount of time goods remain in said warehouse.

7. The system, method, and computer program of claim 1, where the Invention prepares a printed paper report, receipt, or invoice comprising sell rates, buy rates, location of goods, availability of goods,

8. The system, method, and computer program of claim 7, where said report is prepared upon receipt of goods by a 3PL or SCSP.

9. The system, method, and computer program of claim 7, where said report is in electronic format.

10. The system, method, and computer program of claim 9, where said report is prepared upon receipt of goods by a 3PL or SCSP.

11. The system, method, and computer program of claim 1, where users are categorized by the extent of their ability to interact with the Invention.

12. A system, method, and computer program for facilitating goods handling and logistics services commerce comprising:
A computer network;
One or more network access device(s) functionally connected to said network operative to perform functionality including graphical and text user interface and the capability to perform operations;
One or more users;
One or more goods handling and logistics services within a supply chain, comprising of:
Buy-sell functionality
Automatic handling
“Cross-docked” handling
Receipt storage
Anniversary storage
Preparation of electronic and paper reports or invoices;
One or more customers;
One or more servers functionally connected to said network.
